(19) United States
(12) Patent Application Publication
(10) Pub. No.: US 2026/0356248 A1
(43) Pub. Date: Nov. 12, 2026

(54) MOVEMENT SUPPORT MECHANISM

(71) Applicant: Yazaki Corporation, Tokyo (JP)

(72) Inventors: Eri UEDA, Makinohara-shi (JP); Naoto KOGURE, Makinohara-shi (JP); Yasumasa OSADA, Makinohara-shi (JP)

(73) Assignee: Yazaki Corporation, Tokyo (JP)

(21) Appl. No.: 19/637,020

(22) Filed: Apr. 2, 2026

(30) Foreign Application Priority Data
May 7, 2025 (JP) 2025-077359

(51) Int. Cl. B60N 2/015; B60N 2/14; B60R 16/02

(52) U.S. Cl. CPC B60N 2/015; B60N 2/14; B60R 16/0207

(57) ABSTRACT

A movement support mechanism is charactered by including a seat (movement portion); a support portion that is configured to support the seat to be rotatable in a rotating direction of either a clockwise direction or a counterclockwise direction; a wire harness with a length including an rotational excess length so as to be able to track a rotating of the seat; and a housing case that has a housing space interposing between the seat and an arrangement location of the movement support mechanism so as to not to interfere with supporting by the support portion while surrounding the rotating axis, and houses an intermediate portion in the wire harness as the rotational excess length in the housing space in a state of being wound in a spiral shape to surround the rotating axis to make a side of the one end portion thereof to extend toward the seat.

### TECHNICAL FIELD

The present invention relates to a movement support mechanism to support a predetermined movement portion.

### BACKGROUND ART

Conventionally, a movement support mechanism to support a vehicle seat as a movement portion to be slidable in a sliding direction along a travelling direction of the vehicle is known (for example, see Patent Document 1). According to the movement support mechanism described in Patent Document 1, it is possible for the seat to be supported so as to be slidable, and a wire harness is provided to electrically connect an electrical device mounted on the seat to other devices in the vehicle. This wire harness is provided so as to be able to track the sliding of the seat.

### CITATION LIST

### Patent Documents

[Patent Document 1] JP 2022-152943A

### SUMMARY OF THE INVENTION

### Technical Problem

Here, in recent years, there has been a demand for the vehicle seat that it is rotatable such as by reversing the front-to-rear direction. However, with regard to the wire harnesses, it is difficult for the conventional configurations being designed to track the sliding to track the rotating, and a movement support mechanism that enables the wire harness to follow the rotating of the seat is desired.

Also, up to this point, the technical problem of the demand for the movement support mechanism that enables the wire harness to track the rotating of the seat has been explained using the example of a mechanism that supports a vehicle seat. However, although such technical problem is a typical technical problem within the vehicle seats, it is not limited thereto. That is, the above-mentioned technical problem can generally occur in any mechanism that supports a movement portion, as long as the mechanism is the movement support mechanism to support the movement portion in which an electrical device being electrically connected to other devices via the wire harness to operate is mounted.

Therefore, the present invention has been made in view of the above-mentioned technical problems, and an object thereof is to provide a movement support mechanism that can make a wire harness to follow a rotating of a movement portion.

### Solution to Problem

In order to solve the above-described technical problem, a movement support mechanism is characterized by including a movement portion arranged in a predetermined arrangement location and to which an electrical device that is electrically connected to another device to operate is mounted; a support portion that is interposed between the movement portion and the arrangement location, and is configured to support the movement portion to be rotatable in a rotating direction of either a clockwise direction or a counterclockwise direction around a rotating axis as a center that is orthogonal to the arrangement location while passing through the movement portion; a wire harness with one end portion disposed on the movement portion for connecting with the electrical device and another end portion disposed at a position being apart from the movement portion for connecting with the other device, wherein a length between both end portions is set to a length including a rotational excess length so as to be able to track a rotating of the movement portion; and a housing case that has a housing space interposing between the movement portion and the arrangement location so as to not to interfere with supporting for the movement portion by the support portion while surrounding the rotating axis, and houses an intermediate portion in the wire harness as the rotational excess length in the housing space in a state of being wound in a spiral shape to surround the rotating axis to make a side of the one end portion thereof to extend toward the movement portion.

### Effect of the Invention

According to the above-described movement support mechanism, it is possible to make the wire harness to track the rotating of the movement portion.

### BRIEF DESCRIPTION OF THE DRAWINGS

FIG. 1 is a schematic view showing a movement support mechanism according to a first embodiment in an intermediate state in which a seat as a movement portion is not rotated in either rotating direction including a clockwise direction and a counterclockwise direction.

FIG. 2 is a schematic view showing a support portion and a housing case shown in FIG. 1 in an enlarged manner.

FIG. 3 is a schematic view showing the movement support mechanism shown in FIG. 1 in a state in which the seat has rotated for 360 degrees in the clockwise direction.

FIG. 4 is a schematic view showing a support portion and a housing case shown in FIG. 3 in an enlarged manner.

FIG. 5 is a schematic view showing the movement support mechanism shown in FIG. 1 in a state in which the seat has rotated for 360 degrees in the counterclockwise direction.

FIG. 6 is a schematic view showing a support portion and a housing case shown in FIG. 5 in an enlarged manner.

FIG. 7 is a schematic view showing an axial portion and a rotational excess length in the most winding state shown in FIG. 3 and FIG. 4.

FIG. 8 is a schematic view showing a movement support mechanism according to a second embodiment in a state in which the seat has rotated for 360 degrees in the clockwise direction by using the same sectional view in FIG. 3.

FIG. 9 is a schematic view showing a support portion and a housing case shown in FIG. 8 in an enlarged manner.

FIG. 10 is a schematic view showing a movement support mechanism according to a third embodiment in a state in which the seat has rotated for 360 degrees in the clockwise direction by using the same sectional view in FIG. 3.

FIG. 11 is a schematic view showing a support portion and a housing case shown in FIG. 10 in an enlarged manner.

### DESCRIPTION OF EMBODIMENTS

Hereinafter, an embodiment of a movement support mechanism will be described. At first, a first embodiment will be described.

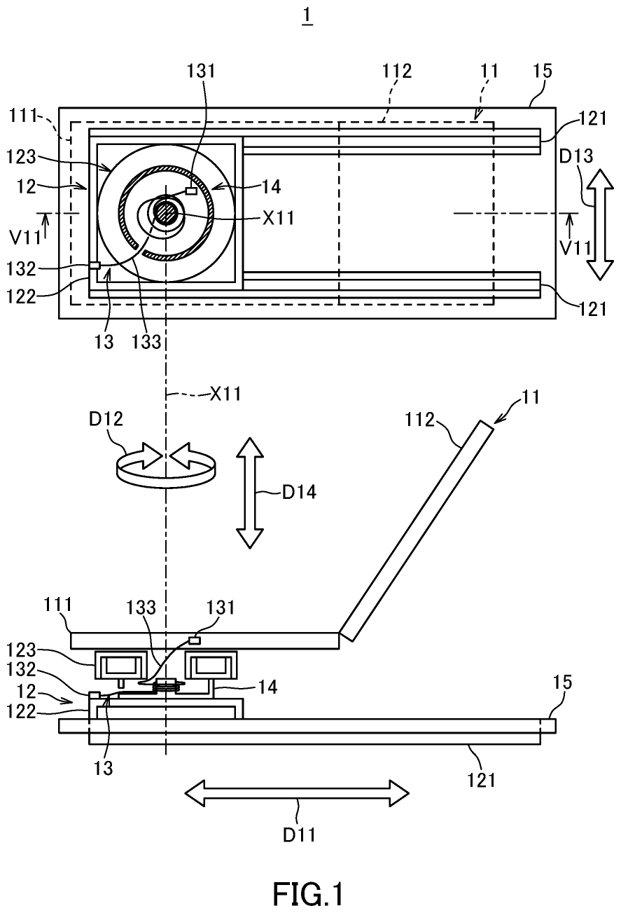

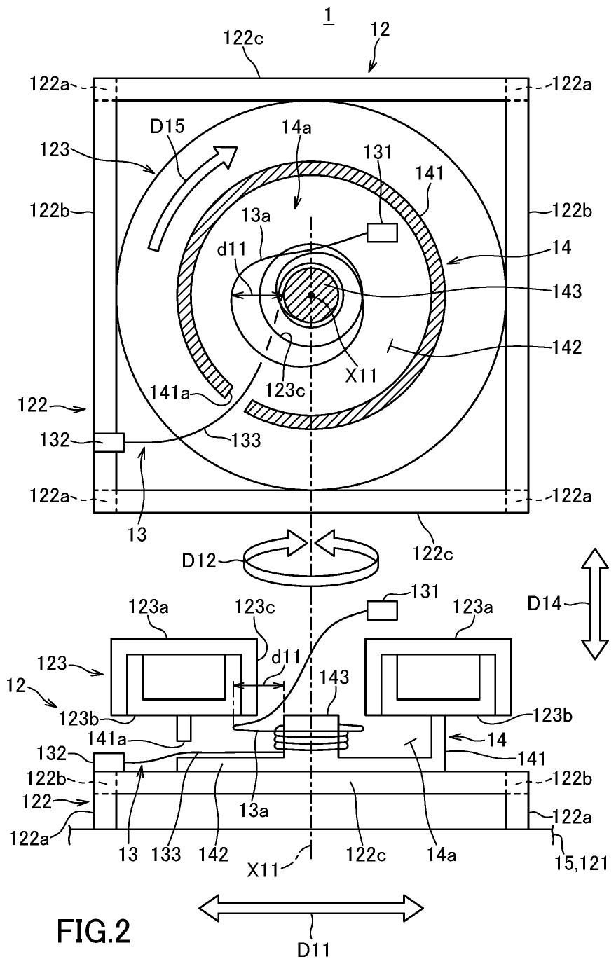

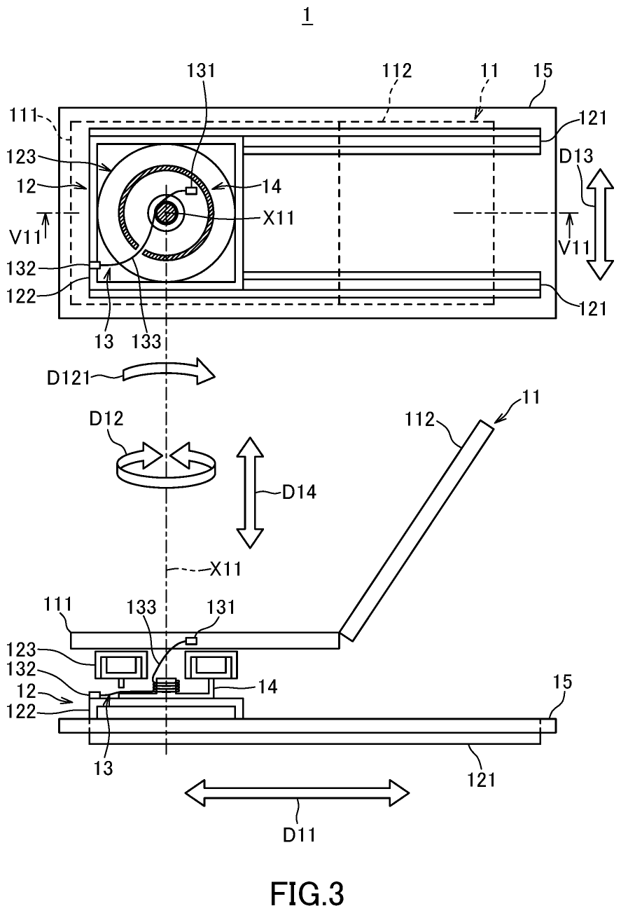

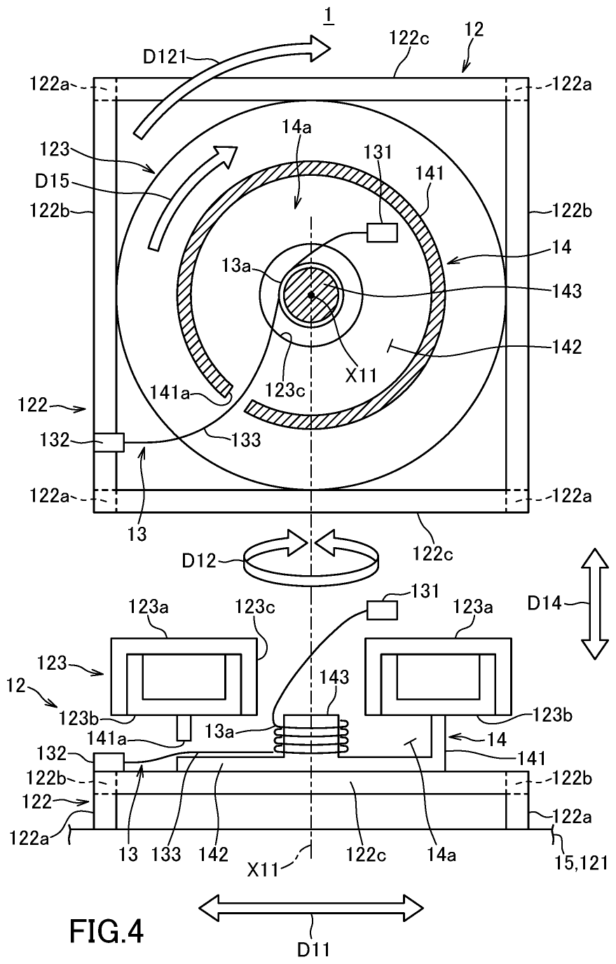

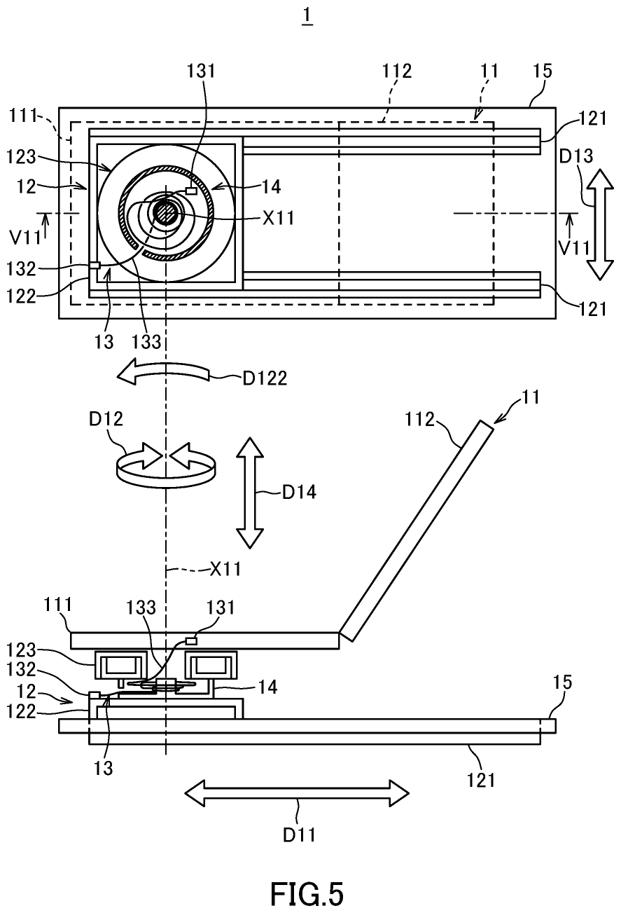

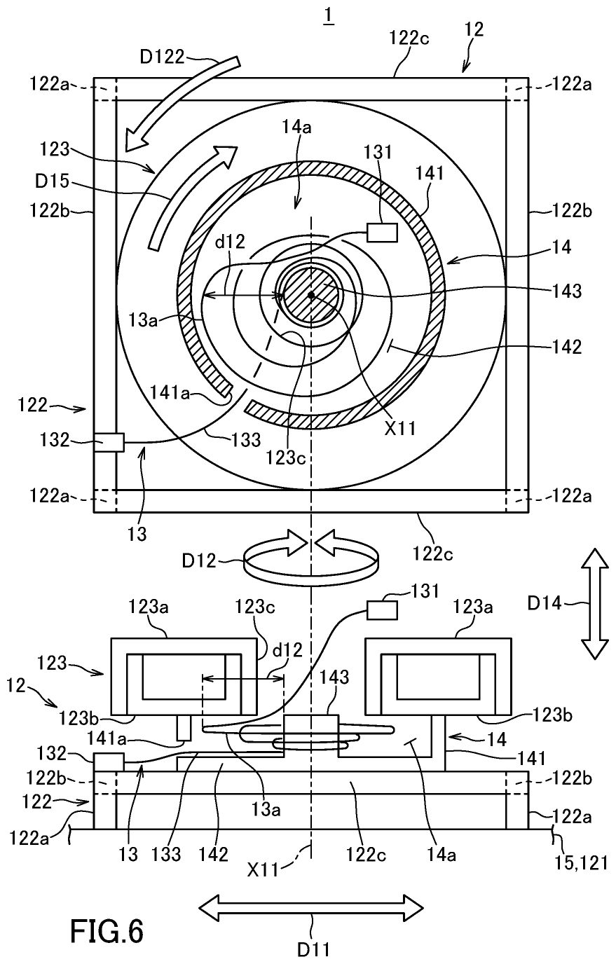

FIG. 1 is a schematic view showing a movement support mechanism according to a first embodiment in an intermediate state in which a seat as a movement portion is not rotated in either rotating direction including a clockwise direction and a counterclockwise direction, and FIG. 2 is a schematic view showing a support portion and a housing case shown in FIG. 1 in an enlarged manner. Then, FIG. 3 is a schematic view showing the movement support mechanism shown in FIG. 1 in a state in which the seat has rotated for 360 degrees in the clockwise direction, and FIG. 4 is a schematic view showing a support portion and a housing case shown in FIG. 3 in an enlarged manner. The, FIG. 5 is a schematic view showing the movement support mechanism shown in FIG. 1 in a state in which the seat has rotated for 360 degrees in the counterclockwise direction, and FIG. 6 is a schematic view showing a support portion and a housing case shown in FIG. 5 in an enlarged manner. In FIG. 1, FIG. 3, and FIG. 5, a movement support mechanism 1 is schematically shown in a plan viewing a seating portion 111 of a seat 11 as the movement portion together with a cross-sectional view along the line V11-V11 in the plan view are schematically shown such that a wiring state of a wire harness 13 can be seen.

The movement support mechanism 1 according to the present embodiment is a mechanism for supporting the seat 11 as the movement portion in a vehicle such as a passenger car so as to be slidable and rotatable as discussed below. Here, the sliding refers to a movement in a linear sliding direction D11 along a travelling direction of the vehicle, and the rotating refers to a rotating in a vertical direction of the vehicle, that is, in a rotating direction D12 around a rotating axis X11 that intersects with the sliding direction D11. Also, with regard to the rotating, it is assumed that a rotating by 360 degrees in either direction of the clockwise direction and the counterclockwise direction. Such movement support mechanism 1 includes a seat 11 as the movement portion, a support portion 12, a wire harness 13, and a housing case 14.

The seat 11 is a vehicle seat in which an electrical device that is electrically connected with other devices to operate is mounted. For example, as the electric devices mounted in this seat 11, a sensor that detects whether a passenger is seated, a heater that warms the seating portion 111 and a backrest 112 of the seat 11, and the like are included. Other devices being connected to these electrical devices include a power supply device that supplies power to the electrical devices, a control device that exchanges signals with the electrical devices, and the like.

The support portion 12 is a mechanism that supports the seat 11 so as to make it to be slidable in a linear sliding direction D11 and rotate by 360 degrees in a rotating direction D12 around a rotating axis X11, and it is mounted on a floor frame of the vehicle. The support portion 12 includes a pair of slide rails 121, a base frame 122, and a rotating support mechanism 123.

The slide rail 121 is a portion extending in the sliding direction D11 that is sandwiched between a carpet 15 covering a floor frame of the vehicle and the floor frame. The slide rails 121 are parallelly arranged in a pair in an arrangement direction D13 orthogonal to the sliding direction D11 and the rotating axis X11, at an interval corresponding to a width dimension of the seat 11 in the arrangement direction D13.

The base frame 122 is a portion connected with the slide rail 121 through the carpet 15 so as to be slidable in the sliding direction D11. This base frame 122 is a member having a thin rectangular parallelepiped appearance. The base frame 122 has a plurality of (four) leg frames 122a, two first frame portions 122b extending in a rod-like shape along the arrangement direction D13 of the slide rail 121, and two second frame portions 122c extending in a rod-like shape along the sliding direction D11. The two first frame portions 122b and the two second frame portions 122c form a rectangular frame, and one leg frame 122a extends from each of the four corners of the rectangular frame toward the slide rail 121. Regarding the four leg frames 122a, each two leg frames 122a are connected to the one slide rail 121 such that each extending end portion is slidable.

The rotating support mechanism 123 is disposed to be interposed between the seat 11 as the movement portion and the floor frame as the arrangement location in the axial direction D14 of the rotating axial X11. Then, the rotating support mechanism 123 is a portion to support the seat 11 to be rotatable around the rotating direction D12 as either of the clockwise direction and the counterclockwise direction with the rotating axis X11 through the seating portion 111 of the seat 11 while being orthogonal to the floor frame. According to the present embodiment, this rotating support mechanism 123 is arranged to be sandwiched between the base frame 122 and the seat 11. The rotating support mechanism 123 has an annular appearance located inside a rectangular frame formed by the two first frame portions 122b and the two second frame portions 122c in a plan view when viewed from the axial direction D14.

This rotating support mechanism 123 includes a rotating side annular portion 123a and a fixing side annular portion 123b. The rotating side annular portion 123a is a portion fixed to the seating portion 111 of the seat 11 to rotate together with the seat 11 in the rotating direction D12. On the other hand, the fixing side annular portion 123b is a portion being fixed to the base frame 122 via the housing case 14 while rotatably connecting with the rotating side annular portion 123a. According to the present embodiment, either of the rotating side annular portion 123a and the fixing side annular portion 123b has an annular groove shape. The rotating side annular portion 123a is formed as a groove with a wider width than that of the fixing side annular portion 123b to connect with the fixing side annular portion 123b so as to put the fixing side annular portion 123b at the internal side while the groove bottom wall is fixed to the seating portion 111 of the seat 11. One of the fixing side annular portions 123b has the groove bottom wall fixed to the base frame 122 via the housing case 14. During the rotating, the rotating side annular portion 123a rotates while the groove inner wall surface thereof rubs against the groove outer wall surface of the fixing side annular portion 123b.

The support portion 12 includes the above-mentioned pair of slide rails 121, the base frame 122, and the rotating support mechanism 123 such that the seat 11 is supported to be slidable in the sliding direction D11 and rotatable around the rotating axis X11.

The wire harness 13 is a harness member having a first connector 131 as one end portion disposed in the seat 11 for connecting with an electrical device and a second connector 132 as the other end portion disposed at a position away from the seat 11 for connecting with another device. Such wire harness 13 includes the first connector 131, the second connector 132, and a harness electric wire 133 connecting these two connectors. The first connector 131 is embedded in the seating portion 111 of the seat 11, and the second connector 132 is fixedly arranged on the upper surface of the first frame portion 122b in the base frame 122. Then, a length between both end portions of the wire harness 13, that is, the length of the harness electric wires 133, is set to a length that includes an rotational excess length 13a that can track the rotating of the seat 11.

The housing case 14 is a member having a housing space 14a interposing between the seat 11 as the movement portion and the floor frame as the arrangement location so as to not to interfere with supporting for the seat 11 by the rotating support mechanism 123 of the support portion 12 while surrounding the rotating axis X11. According to the present embodiment, this housing case 14 is arranged between the base frame 122 and the rotating support mechanism 123 as the arrangement location. The housing case 14 is fixed to the base frame 122 while being fixed to groove bottom wall of the fixing side annular portion 123b in the rotating support mechanism 123. Then, this housing case 14 has a cylindrical shape with a bottom, including a cylindrical peripheral wall 141 and a circular bottom wall 142. The circular bottom wall 142 is fixed to the base frame 122, and the groove bottom wall of the fixing side annular portion 123b is fixed to the opening side edge of the peripheral wall 141. Also, inside the housing space 14a, an axial portion 143 extending along the rotation axis X11 is provided to protrude from the center of the circular bottom wall 142. Regarding the cylindrical axial portion 143, an outer diameter thereof is smaller than the inner diameter of the inner cylindrical hole 123c in the annular rotating support mechanism 123, and the protruding height from the circular bottom wall 142 is approximately the same as the height of the peripheral wall 141.

This housing case 14 houses an intermediate portion in the wire harness 13 as the rotational excess length 13a in the housing space 14a in a state of being wound in a spiral shape surrounding the rotating axis X11 to make the first connector 131 side as the one end portion to extend toward the seating portion 111 of the seat 11. At this time, the side of the first connector 131 of the wire harness 13 passes through a gap between the inner cylindrical hole 123c of the rotating support mechanism 123 and the protruding end portion of the axial portion 143 to extend toward the seating portion 111. Also, the side of the second connector 132 as the other end portion passes through the harness outlet hole 141a provided on the peripheral wall 141 to extend toward the first frame portion 122b of the base frame 122.

Then, although it is not shown in figures, the floor side wire harness, having a length including a sliding excess length so as to be able to track the sliding of the swat 11 in the sliding direction D11, is connected to the second connector 132 fixedly provided in the first frame portion 122b in a connector manner. The wire harness 13 is connected with other devices via this floor side wire harness.

At this time, according to the present embodiment, regarding the wire harness 13, in an intermediate state (see FIG. 1 and FIG. 2) in which the seat 11 is not rotated in either of the rotating direction D12 including the clockwise direction and the counterclockwise direction, the rotational excess length 13a is wound on the axial portion 143 as shown below. That is, in such intermediate state, as shown in FIG. 1 and FIG. 2, at least a portion thereof (in the example shown in figures, a portion at the side of the first connector 131) is wound on the axial portion 143 in a state in which the gap d11 therebetween with the axial portion 143 is open. Also, according to the present embodiment, the rotational excess length 13a of the wire harness 13 is wound in a spiral shape on the axial portion 143 in a clockwise winding direction D15.

Then, the rotational excess length 13a is wound in the clockwise direction such that according to the present embodiment, when the seat 11 rotates in the clockwise direction D121 of the rotating direction D12 around the rotating axis X11, the wire harness 13 tracks the rotating of the seat 11 as follows. That is, at this time, by winding on the axial portion 143 from the side of the first connector 131, the number of turns of the rotational excess length 13a is increased and the gap d11 therebetween with the axial portion 143 is narrowed so as to track the rotating of the seat 11. According to the present embodiment, as shown in FIG. 3 and FIG. 4, in a state in which the seat 11 rotates by 360 degrees in the clockwise direction D121, the number of turns from the intermediate state shown in FIG. 1 and FIG. 2 is increased by one turn. Also, at this time, the gap d11 therebetween with the axial portion 143 has become approximately zero such that the rotational excess length 13a enters the state of tightening the axial portion 143. According to the present embodiment, the number of turns that is increased by one turn from this intermediate state becomes the maximum number of turns.

On the other hand, when the seat 11 rotates in the counterclockwise direction D122 that is opposite to the clockwise winding direction D15, the wire harness 13 is unwound from the side of the first connector 131, thereby reducing the number of turns of the rotational excess length 13a. Furthermore, the wire harness 13 expands the gap d11 therebetween with the axial portion 143 to track the rotating of the seat 11. As shown in FIG. 5 and FIG. 6, in the state in which the seat 11 rotates by 360 degrees in the counterclockwise direction D122, the number of turns from the intermediate state shown in FIG. 1 and FIG. 2 is decreased by one turn. Furthermore, part of the harness portion at the side of the first connector 131 is unwound until the vicinity of the inner wall surface of the peripheral wall 141 in the housing case 14 such that the gap d12 therebetween with the axial portion 143 is correspondingly in the expanded state.

Here, according to the present embodiment, the length of the rotational excess length 13a in the wire harness 13 is set as follows based on the most winding state shown in FIG. 3 and FIG. 4.

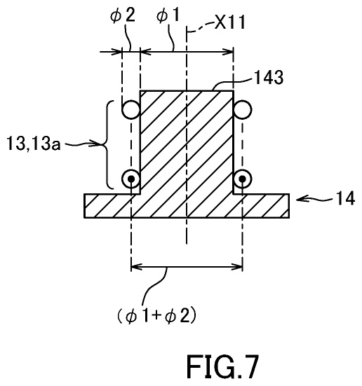

FIG. 7 is a schematic view showing the axial portion and the rotational excess length in the most winding state shown in FIG. 3 and FIG. 4.

In this FIG. 7, the most winding state in which the rotational excess length 13a in the wire harness 13 is wound with respect to the axial portion 143 in the housing case 14 in the state in which the gap therebetween with the axial portion 143 is approximately zero is shown in a sectional view including the rotating axis X11. Then, when the length of the rotational excess length 13a is referred to as L, the outer diameter of the axial portion is referred to as φ1, the harness outer diameter of the wire harness 13 is referred to as φ2, and the maximum number of turns is referred to as N, the length of the rotational excess length 13a is set to satisfy the following formula (1).

((φ1+φ2)×π)×N<L (1)

According to the movement support mechanism 1 of the above-described first embodiment, when the seat 11 as the movement portion being supported by the support portion 12 rotates, in corresponding to the rotating direction D12 thereof, the wire harness 13 tracks the rotating of the seat 11 as follows. That is, in the case in which the rotating direction D12 of the seat 11 is the same as the spiral winding direction D15, the wire harness 13 is configured to increase the number of turns of the rotational excess length 13a so as to track the rotating of the seat 11. On the other hand, in the case in which the rotating direction D12 of the seat 11 is opposite to winding direction D15, the wire harness 13 is configured to decrease the number of turns of the rotational excess length 13a so as to track the rotating of the seat 11. In this manner, according to the above-described movement support mechanism 1, it is possible to make the wire harness 13 to track the rotating of the seat 11 as the movement portion.

Here, according to the present embodiment, the support portion 12 includes the base frame 122 and the rotating support mechanism 123, wherein the housing case 14 is arranged between the base frame 122 and the rotating support mechanism 123 as the arrangement location. According to such configuration, due to the fixedly arrangement of the housing case 14 to the base frame 122, it is possible to stably house the rotational excess length 13a in the wire harness 13. Also, by directly supporting the seat 11 by the rotating support mechanism 123, it is possible to improve the stability of this support.

According to the present embodiment, regarding the wire harness 13, the side of the second connector 132 extends outside from the housing case 14 to be fixedly arranged to the base frame 122. According to such configuration, the side of the second connector 132 at the opposite side of the seat 11 in the wire harness 13 is fixedly arranged at the outside of the housing case 14. Due to such fixed arrangement, inside the housing case 14, it is possible to effectively perform the tracking by the winding and the unwinding in response to the movement of the side of the first connector 131 as the side of the seat 11.

According to the present embodiment, in the intermediate state when the seat 11 is not rotated, at least a portion of the rotational excess length 13a of the wire harness 13 is wound around the axial portion 143 with the gap d11 existing therebetween with the axial portion 143 inside the housing case 14. According to such configuration, the rotational excess length 13a is wound on the axial portion 143 so as to stabilize the position of the rotational excess length 13a in the winding state inside the housing case 14. Also, in the intermediate when the seat 11 is not rotated, the gap d11 exists between at least part of the rotational excess length 13a and the axial portion 143. Due to such gap d11 in the intermediate state, it is possible to make the rotational excess length 13a to smoothly track the rotating of the seat 11 by increasing and decreasing the number of turns with respect to the axial portion 143 while expanding and narrowing the gap d11.

According to the present embodiment, the above formula (1) is established between the length L of the rotational excess length 13a of the wire harness 13, the outer diameter φ1 of the axial portion 143, the harness outer diameter φ2 of the wire harness 13, and the maximum number of turns N around the axial portion 143. According to such configuration, it is possible to effectively set the length of the rotational excess length 13a of the wire harness 13 by using formula (1) during the design period.

Hereinbefore, the description of the first embodiment has been concluded, and subsequently, a second embodiment will be described. This second embodiment differs from the first embodiment in the arrangement location and configuration of the housing case. The following description of the second embodiment will focus on the differences from the first embodiment.

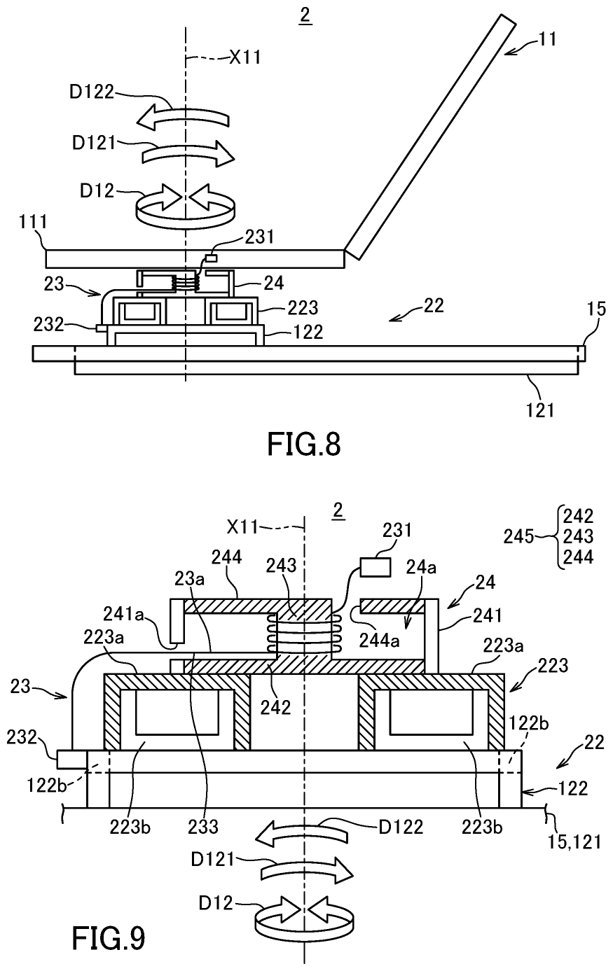

FIG. 8 is a schematic view showing a movement support mechanism according to a second embodiment in a state in which the seat has rotated for 360 degrees in the clockwise direction by using the same sectional view in FIG. 3. Also, FIG. 9 is a schematic view showing a support portion and a housing case shown in FIG. 8 in an enlarged manner. In addition, in FIG. 8 and FIG. 9, components that are equivalent to those according to the first embodiment shown in FIG. 1 to FIG. 7 are denoted by the same reference numerals as in FIG. 1 to FIG. 7 only for those components necessary to be described, and the duplicate explanations of these equivalent components will be omitted below.

In the movement support mechanism 2 according to the present embodiment, a rotating support mechanism 223 is attached to a base frame 122 that is connected to a slide rail 121 through a carpet 15. More specifically, a fixing side annular portion 223b of the rotating support mechanism 223 is fixedly arranged on the base frame 122, and a rotating side annular portion 223a is connected to this fixing side annular portion 223b so as to be rotatable in the rotating direction D12. According to the present embodiment, the support portion 22 includes the slide rail 121, the base frame 122, and the rotating support mechanism 223 being in such connecting state.

Then, the housing case 24 is arranged between the rotating support mechanism 223 attached to the base frame 122 as described above and the seating portion 111 of the seat 11 as the movement portion as the arrangement location. The housing case 24 includes a cylindrical peripheral wall 241, a circular bottom wall 242, an axial portion 243, and a circular ceiling wall 244. The circular bottom wall 242, the axial portion 243, and the circular ceiling wall 244 are integrated to form a rotating portion 245 of the housing case 24. The peripheral wall 241 surrounds the outer periphery of the rotating portion 245 and is provided in a separate state from the rotating portion 245 such that the rotating portion 245 is rotatable around the rotation axis X11 inside the peripheral wall 241. Then, the circular bottom wall 242 in the rotating portion 245 is fixed to the rotating side annular portion 223a of the rotating support mechanism 223, and the circular ceiling wall 244 of the rotating portion 245 is fixed to the seating portion 111 of the seat 11. Due to such fixing configuration, when the seat 11 rotates in the rotation direction D12 around the rotating axis X11, the rotating portion 245 and the rotating side annular portion 223a, which are shown by hatching in FIG. 9, rotate together with the seat 11.

Regarding the wire harness 23, the intermediate portion as the rotational excess length 23a is wound in a clockwise spiral shape around the axial portion 243 in the housing space 24a of the housing case 24. The side of the first connector 231 as the side of the seat 11 passes through a first harness outlet hole 244a formed in the circular ceiling wall 244 of the rotating portion 245 and extends toward the seating portion 111, wherein the first connector 231 is embedded in this seating portion 111. The second connector 232 on the other side passes through a second harness outlet hole 241a formed in the peripheral wall 241 and extends toward the first frame portion 122b of the base frame 122. As shown in FIG. 9, the second connector 232 is fixedly arranged on the lateral surface of the first frame portion 122b. When the seat 11 rotates, the rotating of the peripheral wall 241 is restricted by the harness wires 233 passing through the second harness outlet hole 241a.

When the seat 11 rotates in the clockwise direction D121, the rotational excess length 23a is wound around the axial portion 243 from the side of the second connector 232. On the other hand, when the seat 11 rotates in the counterclockwise direction D122, the rotational excess length 23a is unwound from the side of the second connector 232.

Due to the above-described movement support mechanism 2 according to the second embodiment, similar to the above-described first embodiment, it is obvious that it is also possible to make the wire harness 23 to track the rotating of the seat 11 as the movement portion.

Also, according to the present embodiment, the housing case 24 is arranged between the rotating support mechanism 223 and the seat 11 as the movement portion, as the arrangement location. Due to such configuration, by fixing the rotating support mechanism 223 to the base frame 122, it is possible to stabilize the rotating of the seat 11 via the rotating support mechanism 223. Also, the distance, between the first connector 231 of the wire harness 23 embedded in the seat 11 and the axial portion 243 onto which the harness portion on the first connector 231 side is wound, is shortened. By shortening such distance, it is possible to improve the winding property around the axial portion 243.

Hereinbefore, the description of the second embodiment has been concluded, and subsequently, a third embodiment will be described. This third embodiment differs from the first embodiment in the arrangement location and configuration of the housing case, and the configuration of the rotating support mechanism. The following description of the third embodiment will focus on the differences from the first embodiment.

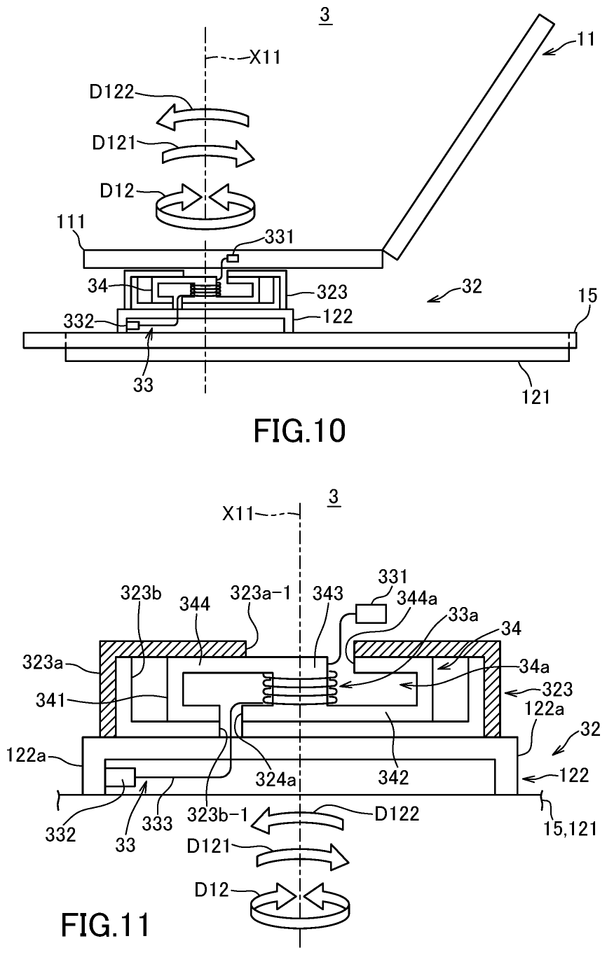

FIG. 10 is a schematic view showing a movement support mechanism according to a third embodiment in a state in which the seat has rotated for 360 degrees in the clockwise direction by using the same sectional view in FIG. 3. Also, FIG. 11 is a schematic view showing a support portion and a housing case shown in FIG. 10 in an enlarged manner. It is noted that in FIG. 10 and FIG. 11, the components equivalent to those according to the first embodiment shown in FIG. 1 to FIG. 7 are assigned the same reference numerals as those in FIG. 1 to FIG. 7 only for those components necessary for explanation, and the redundant explanation of these equivalent components will be omitted below.

In the movement support mechanism 3 according to the present embodiment, a support portion 32 is configured by attaching a rotating support mechanism 323 to a base frame 122 that is connected to a slide rail 121 through the carpet 15. Unlike the first embodiment and the second embodiments described above, the rotating support mechanism 323 is a hollow can-shaped portion rather than the annular shape. The rotating support mechanism 323 includes a rotating side portion 323a and a fixing side portion 323b. The rotating side portion 323a is fixed to the seating bottom 111 of the seat 11 and rotates in the rotation direction D12 together with the seat 11. On the other hand, the fixing side portion 323b is fixed to the base frame 122 while being a portion to which the rotating side portion 323a is rotatably connected. According to the present embodiment, the rotating side portion 323a has a cylindrical shape with a lid, and the fixing side portion 323b has a cylindrical shape with a closed bottom with a diameter slightly smaller than that of the rotating side portion 323a. The rotating side portion 323a is connected to the fixing side portion 323b so as to be fit at the inner side of the fixing side portion 323b, and the ceiling wall is fixed to the bottom portion 111 of the seat 11. The fixing side portion 323b has a bottom wall fixed to the base frame 122. When rotating, the rotating side portion 323a rotates while its inner peripheral wall surface thereof rubs against the outer peripheral wall surface of the fixing side portion 323b.

The housing case 34 is arranged inside the rotating support mechanism 323 attached to the base frame 122 as described above, more specifically, inside the fixing side portion 323b as the arrangement location. The housing case 34 is an integrated portion consisting of a cylindrical peripheral wall 341, a circular bottom wall 342, an axis portion 343, and a circular ceiling wall 344. Then, it is arranged inside the fixing side portion 323b with the circular bottom wall 342 fixed to the bottom wall of the fixing side portion 323b. When the seat 11 rotates in the rotation direction D12 around the rotation axis X11, the rotating side portion 323a of the rotating support mechanism 323, shown hatched in FIG. 9, rotates together with the seat 11 while rubbing against the circular ceiling wall 344 of the housing case 34.

Regarding the wire harness 33, an intermediate portion as the rotational excess length 33a is wound in a clockwise spiral around the axial portion 343 in the housing space 34a of the housing case 34. The side of the first connector 331 as the side of the seat 11 extends through a first harness outlet hole 344a provided in a circular ceiling wall 344 of the housing case 34. At this time, a central circular hole 323a-1 is provided in the center thereof in the rotating side portion 323a of the rotating support mechanism 323. This central circular hole 323a-1 is formed as a hole with a large diameter such that the first harness outlet hole 344a fits inside thereof no matter how the rotating side portion 323a rotates in the rotation direction D12 around the rotating axis X11. The side of the first connector 331 of the wire harness 33 that has exited through the first harness outlet hole 344a passes through the large-diameter central circular hole 323a-1 and reaches the seating portion 111 of the seat 11, wherein the first connector 331 is embedded in the seating portion 111. On the other hand, the side of the second connector 332 extends through a second harness outlet hole 342a provided in the circular bottom wall 342 of the housing case 34. Also, an outlet communication hole 323b-1 is provided in the bottom wall of the fixing side portion 323b of the rotating support mechanism 323 so as to communicate with the second harness outlet hole 342a. The side of the second connector 332 of the wire harness 33 extends such that the harness wires 333 pass through the second harness outlet hole 342a and the outlet communication hole 323b-1, and leads to one of the leg frames 122a of the base frame 122. Then, as shown in FIG. 11, the second connector 332 is fixedly arranged on the inner side surface of this one leg frame 122a.

When the seat 11 rotates in the clockwise direction D121, the rotation surplus length 33a is wound around the shaft portion 343 from the first connector 331 side. On the other hand, when the seat 11 rotates in the counterclockwise direction D122, the rotation surplus length 33a is unwound from the first connector 331 side.

Also, due to the above-described movement support mechanism 3 according to the third embodiment, it is obvious that it is possible to make the wire harness 33 to track the rotating of the seat 11 as the movement portion, similar to the above-described first embodiment.

Also, according to the present embodiment, the housing case 34 is arranged inside the rotating support mechanism 323 as the arrangement location. Due to such configuration, the seat 11 as the movement portion is directly supported and rotated by the rotating support mechanism 323, which is stably attached to the base frame 122, so as to improve the stability of the rotating. Furthermore, the distance between the first connector 331 of the wire harness 33 which is embedded in the seat 11, and the axial portion 343 onto which the harness portion on the side of the first connector 331 is wound is shortened. The distance is shortened distance so as to stabilize the movement of the harness portion on the side of the first connector 331 when the seat 11 rotates so as to improve the winding property around the axial portion 343 during the rotating.

In addition, the first embodiment to the third embodiment described above are merely representative examples of the movement support mechanism. The movement support mechanism is not limited thereto and can be implemented in various modifications.

For example, according to the first embodiment to the third embodiment described above, the movement support mechanisms 1, 2, 3 that support the vehicle seat 11 as the movement portion are exemplified as examples of the movement support mechanism. However, the movement support mechanism is not limited thereto, and it may be a mechanism that supports any object other than a seat as the movement portion as long as it is equipped with an electric device that operates by being electrically connected to other devices via the wire harness.

Also, according to the first embodiment to the third embodiment described above, the seat 11 that can rotate by 360 degrees in both the clockwise direction and the counterclockwise direction is exemplified as an example of the movement portion. However, the movement portion is not limited thereto, and any angle can be adopted as the specific rotating angle as long as the movement portion can rotate in both the clockwise direction and the counterclockwise direction.

Also, according to the first embodiment to the third embodiment described above, the support portions 12, 22, 32 that support the seat 11 as the movement portion being slidable and rotatable are exemplified as examples of the support portions. However, the support portion is not limited thereto, and the support portion may support the movement portion so as to be rotatable only.

Also, according to the first embodiment to the third embodiment described above, the wire harnesses 13, 23, 33, in which the floor-side wire harness including the sliding excess slide length is connected by connectors to the second connector 132, 232, 332, are exemplified as examples of the wire harness. The wire harnesses 13, 23, 33 are connected to other devices via the floor-side wire harness. However, the wire harness is not limited thereto, and it may be directly connected to other devices.

Also, according to the first embodiment and the second embodiment described above, the rotating support mechanisms 123, 223 are exemplified as an example of the rotating support mechanism in the support portion, having the circular ring-shaped appearance and including the rotating side annular portion 123a, 223a and the fixing side annular portion 123b, 223b, respectively. Also, according to the third embodiment, the rotating support mechanism 323 is exemplified as a hollow can-shaped mechanism including the rotating side portion 323a and the fixing side portion 323b. However, the rotating support mechanism is not limited thereto. The specific shape and mechanical configuration of the rotating support mechanism are not particularly limited as long as it is interposed between the movement portion and the base frame and supports the movement portion so as to be rotatable in both the clockwise direction and the counterclockwise direction around the rotating axis.

Also, according to the first embodiment described above, the housing case 14 having a cylindrical shape with a bottom while including the cylindrical peripheral wall 141 and the circular bottom wall 142 is exemplified as an example of the housing case. Also, according to the second embodiment, the housing case 24 having the cylindrical peripheral wall 241, the circular bottom wall 242, the axial portion 243, and the circular ceiling wall 244, with the peripheral wall 241 being separate from the other components, is exemplified as an example of the housing case. Furthermore, according to the third embodiment, the housing case 34 in which the cylindrical peripheral wall 341, the circular bottom wall 342, the axial portion 343, and the circular ceiling wall 344 are integrated as a whole, is exemplified as an example of the housing case. However, the housing case is not limited thereto, and the specific shape and case configuration can be set as desired.

Also, according to the first embodiment described above, the housing case 14 that is arranged between the base frame 122 and the rotating support mechanism 123 as the arrangement location is exemplified as an example of the housing case. Also, according to the second embodiment, the housing case 24 that is arranged between the rotating support mechanism 223 and the seat 11 as the movement portion as the arrangement location is exemplified as an example of the housing case. Then, according to the third embodiment, the housing case 34 that is arranged inside the rotating support mechanism 323 as the arrangement location is exemplified. However, the housing case is not limited thereto, and the specific arrangement location is not particularly limited as long as it is located between the arrangement locations of the vehicle seat as the movement portion and the movement support mechanism so as not to interfere with the support of the movement portion by the support portion. However, as described above, by arranging the housing case between the base frame 122 and the rotating support mechanism 123, the rotational excess length 13a can be stably housed inside the housing case 14, and the stability of the support for the seat 11 can be improved. Also, as described above, by setting the arrangement location between the rotating support mechanism 223 and the seat 11 as the movement portion, it is possible to stabilize the rotating of the seat 11 and improving the winding property of the harness portion on the side of the first connector 231 around the axial portion 243. Furthermore, by setting the inside of the rotating support mechanism 323 as the arrangement location, as described above, it is possible to stabilize the rotating of the seat 11 and improving the winding property of the harness portion on the side of the first connector 331 around the axial portion 343.

Also, according to the first embodiment to the third embodiments described above, the wire harnesses 13, 23, 33 in which the side of the second connectors 132, 232, 332 on the side opposite to the seat 11 are fixed to the base frame 122 are exemplified as examples of the wire harnesses. However, the wire harness is not limited thereto, and the side opposite to the movement portion such as the seat may not be fixed to any location. Even if in a case in which they are fixed, the fixing location may be set to any location. However, as described above, by being fixed to the base frame 122, the wire harnesses 13, 23, 33 can effectively track the movement of the wire harnesses by winding and unwinding inside the housing cases 14, 24, 34, respectively.

Furthermore, according to the first embodiment to the third embodiment described above, as an example of the movement support mechanism, the movement support mechanisms 1, 2, 3 in which the rotational excess lengths 13a, 23a, 33a are wound on the axial portions 143, 243, 343 with the gap d11 in the intermediate state in which the seat 11 is not rotated are exemplified. However, the movement support mechanism is not limited thereto, and it may be a configuration to be housed inside the housing case without providing the axial portion wherein the rotational excess length is simply wound in a spiral. However, as described above, by winding the rotational excess lengths 13a, 23a, 33a around the axial portion 143, 243, 343 respectively with the gap d11 in the intermediate state, due to the increasing and decreasing in the number of turns and the widening and narrowing of the gap d11, it is possible to smoothly track the rotating of the seat 11. Also, it is noted that the axial portion is not limited to the cylindrical axial portions 143, 243, 343 exemplified in the first embodiment to the third embodiments, and it may be a cylindrical configuration.

Furthermore, according to the first to third embodiments described above, the movement support mechanisms 1, 2, 3 in which the length L of the rotational excess lengths 13a, 23a, 33a satisfies the above-described formula (1) are given as examples of the movement support mechanism. However, the movement support mechanism is not limited thereto, and the length of the rotational excess length can be set to any length as long as it can track the rotating of a movement portion such as the seat. However, as described above, by using formula (1) during the design period, the length L of the rotational excess lengths 13a, 23a, 33a in the wire harnesses 13, 23, 33 can be effectively set.

### REFERENCE SIGNS LIST

1, 2, 3 movement support mechanism
11 seat (movement portion)
12, 22, 32 support portion
13, 23, 33 wire harness
13a, 23a, 33a rotational excess length
14, 24, 34 housing case
14a, 24a, 34a housing space
15 carpet
111 seating portion
121 slide rail
122 base frame
122a leg frame
122b first frame portion
122c second frame portion
123, 223, 323 rotating support mechanism
123a, 223a rotating side annular portion
123b, 223b fixing side annular portion
123c inner cylindrical hole
131, 231, 331 first connector
132, 232, 332 second connector
133, 233, 333 harness electric wire
141, 241, 341 peripheral wall
141a harness outlet hole
142, 242, 342 circular bottom wall
143, 243, 343 axial portion
241a, 342a second harness outlet hole
244, 344 circular ceiling wall
244a, 344a first harness outlet hole
245 rotating portion
323a rotating side portion
323a-1 central circular hole
323b fixing side portion
323b-1 outlet communication hole
d11 gap
D11 sliding direction
D12 rotating direction
D121 clockwise direction
D122 counterclockwise direction
D13 arrangement direction
D14 axial direction
D15 winding direction
L length of rotational excess length
N maximum number of turns
X11 rotating axis
φ1 outer diameter of axial portion
φ2 outer diameter of harness

What is claimed is:

1. A movement support mechanism, comprising:
a movement portion arranged in a predetermined arrangement location and to which an electrical device that is electrically connected to another device to operate is mounted;
a support portion that is interposed between the movement portion and the arrangement location, and is configured to support the movement portion to be rotatable in a rotating direction of either a clockwise direction or a counterclockwise direction around a rotating axis as a center that is orthogonal to the arrangement location while passing through the movement portion;
a wire harness with one end portion disposed on the movement portion for connecting with the electrical device and another end portion disposed at a position being apart from the movement portion for connecting with the other device, wherein a length between both end portions is set to a length including an rotational excess length so as to be able to track a rotating of the movement portion; and
a housing case that has a housing space interposing between the movement portion and the arrangement location so as to not to interfere with supporting for the movement portion by the support portion while surrounding the rotating axis, and houses an intermediate portion in the wire harness as the rotational excess length in the housing space in a state of being wound in a spiral shape to surround the rotating axis to make a side of the one end portion thereof to extend toward the movement portion.

2. The movement support mechanism according to claim 1,
wherein the support portion includes:
a base frame arranged on a side of the arrangement location in an axial direction of the rotating axis; and
a rotating support mechanism that is interposed between the movement portion and the base frame, and is configured to support the movement portion to be rotatable in the rotating direction of either the clockwise direction or the counterclockwise direction around the rotating axis as the center, and
wherein the housing case is arranged at any one of following arrangement locations including a location interposing between the base frame and the rotating support mechanism, a location interposing between the rotating support mechanism and the movement portion, and a location inside the rotating support mechanism.

3. The movement support mechanism according to claim 2, wherein the wire harness is fixedly arranged to the base frame such that the side of the other end portion extends from the housing case.

4. The movement support mechanism according to claim 1,
wherein the housing case is provided with an axial portion extending in a cylindrical shape or a columnar shape inside the housing space, and
wherein the wire harness is housed in the housing case with the rotational excess length spirally wound around the axial portion, and when the movement portion is in an intermediate state in which it has not rotated in either the clockwise direction or the counterclockwise direction, the rotational excess length is wound around the axial portion with a gap remaining between at least a portion of the rotational excess length and the axial portion.

5. The movement support mechanism according to claim 4,
wherein when a length of the rotational excess length in the wire harness is referred to as L, an outer diameter of the axial portion is referred to as φ1, a harness outer diameter of the wire harness is referred to as φ2, and the maximum number of turns when the rotational excess length is wound most largely around the axial portion due to the rotating of the movement portion is referred to as N, a formula as
((φ1+φ2)×π)×N<L
is satisfied.

6. The movement support mechanism according to claim 1,
wherein the movement portion is a seat mounted in a vehicle,
wherein the arrangement location is a floor frame of the vehicle,
wherein the support portion is a mechanism that is interposed between a seating portion of the seat and the floor frame to support the seat to be rotatable,
wherein the wire harness is a harness to electrically connect the electrical device mounted in the seat to the other device in the vehicle, and
wherein the housing case is a portion arranged to be interposed between the seating portion and the floor frame so as to not interfere with the support of the seating seat by the support portion.
